(19) United States
(12) Patent Application Publication
(10) Pub. No.: US 2020/0285913 A1
(43) Pub. Date: Sep. 10, 2020

(54) METHOD FOR TRAINING AND USING A NEURAL NETWORK TO DETECT EGO PART POSITION

(71) Applicants: Milan Gavrilovic, Uppsala (SE); Andreas Nylund, Rönninge (SE); Pontus Olsson, Stockholm (SE)

(72) Inventors: Milan Gavrilovic, Uppsala (SE); Andreas Nylund, Rönninge (SE); Pontus Olsson, Stockholm (SE)

(21) Appl. No.: 16/811,382

(22) Filed: Mar. 6, 2020

Related U.S. Application Data
(60) Provisional application No. 62/815,618, filed on Mar. 8, 2019.

(51) Int. Cl. G06K 9/62; H04N 5/247; G06T 7/13; B60R 1/00; G05B 13/02; G06N 3/04; G06N 3/08

(52) U.S. Cl. CPC G06K 9/6277; B60R 2300/806; G06T 7/13; G06K 9/6256; B60R 1/00; G05B 13/027; G06N 3/0454; G06N 3/08; G06T 2207/20084; G06T 2207/20081; G06T 2207/30248; G06T 2207/10016; B60R 2300/105; B60R 2300/303; B60R 2300/304; B60R 2300/802; H04N 5/247

(57) ABSTRACT

A vehicle including a vehicle body having a plurality of cameras and at least one ego part connection, an ego part connected to the vehicle body via the ego part connection, a position detection system communicatively coupled to the plurality of cameras and configured to receive a video feed from the plurality of cameras, the position detection system being configured to identify an ego part at least partially imaged in the video feed and configured to determine a closest angular position of the ego part relative to the vehicle using a neural network, and wherein the neural network is configured to determine a probability of the actual angular position being closest to each angular position in a set of predefined angular positions, and determine that the closest angular position of the ego part relative to the vehicle is the predefined angular position having the highest probability.

### CROSS-REFERENCE TO RELATED APPLICATION

This application claims priority to U.S. Provisional Application No. 62/815,618 filed on Mar. 8, 2019.

### TECHNICAL FIELD

The present disclosure relates generally to ego part position detection systems for vehicles, and more specifically to a process for training and using a neural network to provide the ego part position detection.

### BACKGROUND

Modern vehicles include multiple sensors and cameras distributed about all, or a portion, of the vehicle. The cameras provide video images to a controller, or other computerized systems within the vehicle as well as to a vehicle operator. The vehicle operator then uses the video feed to assist in the operation of the vehicle.

In some instances, ego parts (i.e. parts that are connected to, but distinct from, a vehicle) are attached to the vehicle. Certain vehicles, such as tractor trailers, can be connected to multiple distinct types of ego parts. Even within a single category of ego parts, different manufacturers can utilize different constructions resulting in distinct visual appearances of the ego parts that can be connected. By way of example, trailers for connecting to a tractor trailer vehicle can have multiple distinct configurations and distinct appearances.

The distinct configurations and appearances can render it difficult for the operator to track the position of the ego part and can increase the difficulty in implementing an automatic universal ego part position detection system due to the increased variability in the connected ego parts.

### SUMMARY

In one exemplary embodiment a vehicle includes a vehicle body having a plurality of cameras and at least one ego part connection, an ego part connected to the vehicle body via the ego part connection, a position detection system communicatively coupled to the plurality of cameras and configured to receive a video feed from the plurality of cameras, the position detection system being configured to identify an ego part at least partially imaged in the video feed and configured to determine a closest angular position of the ego part relative to the vehicle using a neural network, and wherein the neural network is configured to determine a probability of the actual angular position being closest to each angular position in a set of predefined angular positions, and determine that the closest angular position of the ego part relative to the vehicle is the predefined angular position having the highest probability.

In another example of the above described vehicle each camera in the plurality of cameras is a mirror replacement camera, and wherein a controller is configured to receive the determined closest angular position and pan at least one of the cameras in response to the received angular position.

In another example of any of the above described vehicles the ego part is a trailer, and wherein the trailer includes at least one of an edge marking and a corner marking.

In another example of any of the above described vehicles the neural network is configured to determine an expected position of the at least one of the edge marking and the corner marking within the video feed from the plurality of cameras based on the determined closest angular position of the ego part.

Another example of any of the above described vehicles further includes verifying an accuracy of the determined closest angular position of the ego part by analyzing the video feed from the plurality of cameras and determining that the at least one of the edge marking and the corner marking is in the expected position within the video feed.

In another example of any of the above described vehicles the neural network is trained via transfer learning from a first general neural network to a second specific neural network.

In another example of any of the above described vehicles the first general neural network is pre-trained to perform a task related to identifying the ego part at least partially imaged in the video feed and determining the closest angular position of the ego part relative to the vehicle using a neural network.

In another example of any of the above described vehicles the related task comprises image classification.

In another example of any of the above described vehicles the neural network is the second specific neural network, and is trained to identify the ego part at least partially imaged in the video feed and determine the closest angular position of the ego part relative to the vehicle using a neural network using the first general neural network.

In another example of any of the above described vehicles the second specific neural network is trained using a smaller training set than the first general neural network.

In another example of any of the above described vehicles the neural network includes a number of output neurons equal to the number of predefined positions.

In another example of any of the above described vehicles determining the probability of the actual angular position being closest to each angular position in a set of predefined angular positions, and determining that the closest angular position of the ego part relative to the vehicle is the predefined angular position having the highest probability comprises verifying the determined closest angular position using at least one contextual clue.

In another example of any of the above described vehicles the at least one contextual clue includes at least one of a traveling direction of the vehicle, a speed of the vehicle, a previously determined angular position of the ego part, and a position of at least one key-point in an image.

Another example of any of the above described vehicles further includes a trailer marking system configured to identify a plurality of key-points of the ego part and superimpose markings in a viewing plane over each key-point in the plurality of key-points of the ego part.

In another example of any of the above described vehicles the plurality of key-points includes at least one of a trailer-end and a rear wheel location.

In another example of any of the above described vehicles each key-point in the plurality of key-points is extracted from an image plane and is based at least in part on the determined closest angular position of the ego part.

In another example of any of the above described vehicles the trailer marking system includes at least one physical marking disposed on the trailer, wherein the physical marking corresponds with a key-point in the plurality of key-points.

Another example of any of the above described vehicles further includes a distance line system configured to 3D fit the ego part within an image plane and overlay at least one distance line in the image plane based on a static projection model derived from an average camera and camera placement, wherein the distance line indicates a pre-defined distance between an identified portion of the ego part and the at least one distance line.

In another example of any of the above described vehicles the distance line system assumes flat terrain in positioning the distance line.

In another example of any of the above described vehicles the distance line system further correlates an accurate position of the vehicle with a terrain map and utilizes a current grade of the ego part in positioning the distance line.

### BRIEF DESCRIPTION OF THE DRAWINGS

FIG. 1 illustrates an exemplary vehicle including an ego part connected to the vehicle.

FIG. 2 schematically illustrates an exemplary sample set for training a position tracking neural network.

FIG. 3 illustrates an exemplary method for generating a training set for training the position tracking neural network.

FIG. 4A illustrates a first exemplary image forming a first half of a complete composite image for a training set for training a position tracking neural network.

FIG. 4B illustrates a second exemplary image forming a second half of the complete composite image for a training set for training a position tracking neural network.

FIG. 5 schematically illustrates a method for refining a detected angular position.

FIG. 6 illustrates a single exemplary viewing pane during the method of FIG. 5.

### DETAILED DESCRIPTION

Described herein is a position detection system for use within a vehicle that may potentially interact with other vehicles, objects, or pedestrians during standard operation. The position detection system aids an operator in tracking a position of an ego part, such as a trailer, while making docking maneuvers, turning, reversing, or during any other operation.

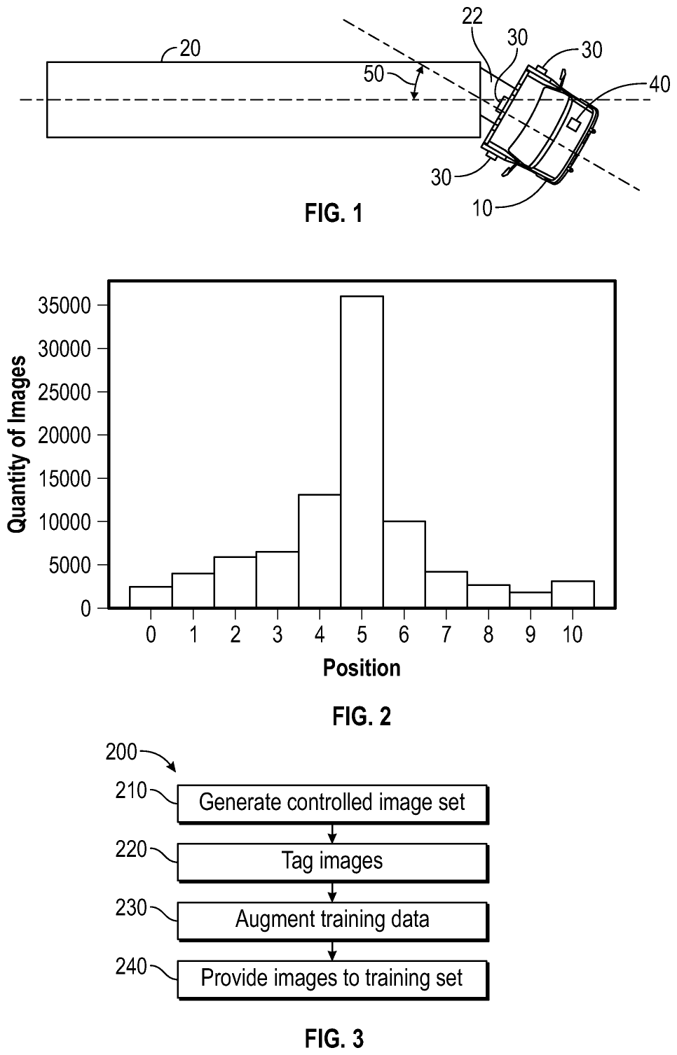

FIG. 1 schematically illustrates one exemplary vehicle 10 including an attached ego part 20 connected to the vehicle 10 via a hitch 22 or any other standard connection. In the illustrated example, the ego part 20 is a trailer connected to the rear of the vehicle 10. In alternative examples, the position detection system described herein can be applied to any ego part 20 and is not limited to a tractor trailer configuration.

Also included on the vehicle 10 are multiple cameras 30, which provide video feeds to a position detection system 40. The position detection system 40 can be included within a general vehicle controller, or be a distinct computer system depending on the particular application. Included within the vehicle 10, but not illustrated for simplicity, are camera mounts, camera housings, a system for processing the data generated by the cameras 30, and multiple additional sensors. In some examples, each of the cameras 30 is integrated with an automatic panning system as part of a mirror replacement system, and the cameras 30 also function as rear view mirrors.

The position detection system 40 incorporates a method for automatically recognizing and identifying ego parts 20 connected to the vehicle 10. In some examples the ego parts 20 can include markings, such as edge or corner markings which can further improve the ability of the position detection system 40 to identify a known type of ego part type. The edge or corner markings can be markings of a specific color or pattern positioned at an edge or corner of the ego part, with one or more systems in the vehicle being configured to recognize the markings. In yet further examples, the position detection system can include an ego part type recognition neural network that is trained to recognize known ego parts 20, and to recognize physical boundaries of unknown ego parts 20.

Once the ego part 20 is recognized and identified, the position detection system 40 analyzes the outputs from the sensors and cameras 30 to determine an approximate angular position (angle 50) of the ego part 20 relative to the vehicle 10. As used herein, the approximate angular position refers to an angular position from a predefined set of angular positions that the ego part 20 is most likely closest to. In the disclosed example, the predefined set of positions includes eleven positions, although the system can be adapted to any other number of predefined positions. The angular position is then provided to any number of other vehicle systems that can utilize the position in their operations. In some examples, the angular position can be provided to a docking assist system, a parking assist system, and/or a mirror replacement system. In yet further examples, the position of the ego part 20 can be provided directly to the operator of the vehicle 10 through a visual or auditory indicator. In yet further examples, the angular position can be provided to an edge mark and/or corner mark detection system. In such an example, the determined angular position is utilized to assist in determining what portions of a video or image to analyze for detecting edge and/or corner markings.

The algorithms contained within the position detection system 40 are neural network based, and track the ego part 20 in combination with, or without, kinematic or other mathematical models that describe the motion of the vehicle 10 and the connected part (e.g. ego part 20) depending on the specifics of the given position detection system 40. The ego part 20 is tracked independent of the source of the action that caused the movement of the part, relative to the vehicle 10. In other words, the tracking of the ego part 20 is not reliant on knowledge of the motion of the vehicle 10.

Usage of kinematic models alone include multiple drawbacks that can render the output of the kinematic model insufficient for certain applications. By way of example, a purely kinematic model of an ego part position does not always work with truck and trailer combinations, such as the combination illustrated in FIG. 1, and kinematic models do not independently work while the vehicle 10 is reversing.

A vision based system for determining the angular position is incorporated into the position detection system 40. The vision based system utilizes a trained neural network to analyze images received from the cameras 30 and determine a best guess of the position of the ego part 20.

The exemplary system utilizes a concept referred to as transfer learning. In transfer learning, a first neural network (N1) is pre-trained on a partly related task using a large available dataset. In one example of the implementation described herein, the partly related task could be image classification. By way of example, the first neural network (N1) can be pre-trained to identify ego parts within an image and classify the image as containing or not containing an ego part. In alternative examples, other neural networks related to the angular position detection of an ego part can be utilized to similar effect. Another similar network (N2) is then trained on the primary task (e.g. trailer position detection) using a smaller number of datapoints and using the first neural network as a starting point and fine tuning the second neural network to better model the primary task.

While it is appreciated that any known or developed neural network can be utilized to perform such a function, including one that does not utilize transfer learning, one example neural network that can perform the position detection well once properly trained is an AlexNet neural network In one example, the AlexNet neural network is a modified AlexNet, with the fully connected layers at the end of the network being replaced by a single Support Vector Machine (SVM) harnessing the features collected from the neural networks. In addition, the number of output neurons are changed from a default 1000 (matching a number of classes in an ImageNet challenge dataset) to the number of predefined trailer positions (in the illustrated non-limiting example, eleven predefined positions). As can be appreciated, this specific example is an example of one possibility and is not exhaustive or limiting.

In one example, the procedure utilized to identify the best guess position of the ego part 20 is a probabilistic spread, where the neural network determines a probability that the ego part is in each possible position. Once the probabilities are determined, the highest probability position is determined to be the most likely position and is used. In some examples, the probabilistic spread can account for factors such as a previous position, direction of travel, etc. that can eliminate or reduce the probability of a subset of the possible positions.

By way of simplified example, based on the images the neural network may determine that position 5 is 83% likely, Position 4 is 10% likely, and position 6 is 7% likely. Absent other information, the position detection system 40 determines that the ego part 20 is in position 5, and responds accordingly. In some examples, the probabilistic determination is further aided by contextual information such as previous positions of the ego part 20. If the ego part 20 was previously determined to be in position 4, and the time period since the previous determination is below a given threshold, the position detection system 40 can know that in some conditions the ego part 0 can only be located in positions 3, 4 or 5. Similarly, if the ego part 20 previously transitioned from position 3 to position 4, the position detection system 40 may know that the ego part 20 can now only be in position 4, 5 or 6 during certain operations. In addition, similar rules can be defined by an architect of the position detection system 40 and/or the neural network which can further increase the accuracy of the probabilistic distribution. In another example, edge markings and/or corner markings may be used to verify the determined angular position of the ego part. In such an example, the system knows which regions of the image should include corner and/or edge markings for a given angular position. If edge and/or corner markings are not detected in the known region, then the system knows that the determined angular position is likely incorrect.

In order to train the neural network to make these determinations, a set of data including known positioning of the ego part 20 is generated and provided to the neural network. The data is referred to herein as a training set, but can otherwise be referred to as a learning population. To generate the training set, video is captured from the cameras 30 during controlled and known operation of the vehicle 10. In order to ensure the ability to detect multiple different configurations and models of trailers, the capturing is repeated with multiple distinct trailers (ego parts 20). As the videos are captured in a known and controlled environment, the actual position of the ego part 20 is known at every point within the video feed, and the images from the feed can be manually or automatically tagged accordingly.

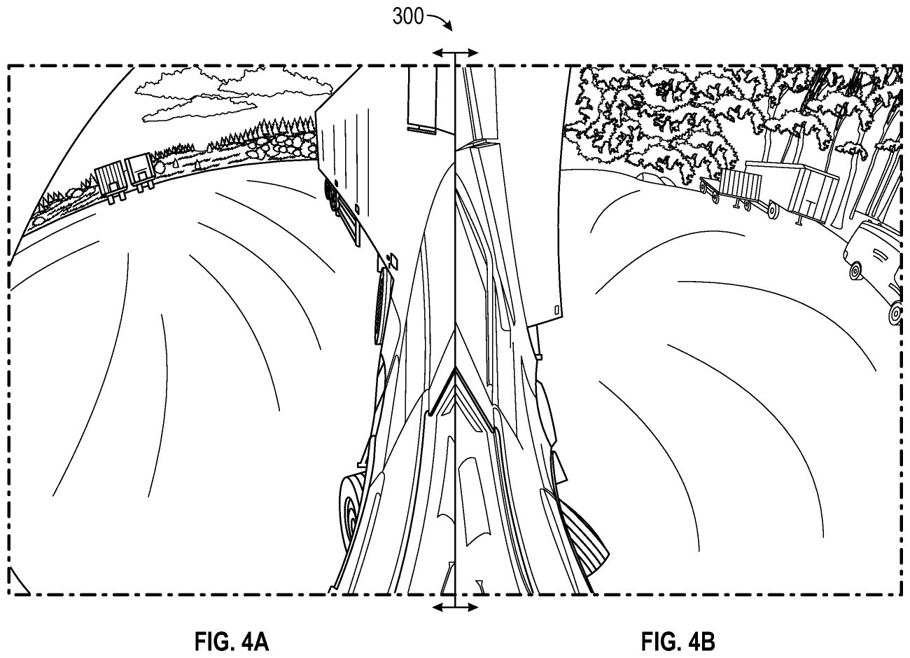

The image streams are time correlated into a larger single image for any given time period. The larger images are cropped and rotated to provide the same view that would be provided to a driver. In one example, the training image uses two side cameras 30 side by side (e.g. FIGS. 4A and 4B). Once the feeds are modified to contain only the images that would be seen by the operator, the feeds are split into a number of sets equal to the number of predefined positions (e.g. 11). Which segments of the feed fall within which sets is determined based on the known angular position of the trailer in that segment.

Each video then provides thousands of distinct frames with the ego part 20 in a known position which are added to the training set of data. By way of example, some videos can provide between 500 and 5000 distinct frames, although the exact number of frames depends on many additional factors including the variability of the ego part(s), the weather, the environment, the lighting, etc. In some examples, every frame is tagged and included in the training set. In other examples, a sampling rate of less than every frame is used. Each frame, or a subset of frames depending on the sampling rate, is tagged with the position and added to the training set.

It is appreciated that the trailer can be in an infinite number of actual positions, as it transitions from one angular position to another. As used herein, the determined angular position is the angular position from a set of predetermined angular positions that the trailer is most likely to be in or transitioning into.

It is also appreciated that certain positions will occur more frequently than others during any given operation of the vehicle 10 including during the controlled operation for generating the data set. FIG. 2 illustrates an example breakdown of a system including eleven positions (0-10), with position 5 having an angle 50 of 0/180 degrees (center position), and each increment or decrement skewing from that position. As can be seen, position 5 occurs substantially more frequently and, as a result, is oversampled. In contrast, the extreme outermost positions 0, 1, 9 and 10 occur substantially less frequently and are undersampled. In order to provide sufficient data in each of the more extreme positions, the positions can be oversampled relative to the center position 5 using any conventional oversampling technique. By way of example, if the standard sampling rate is 2 images per second, the oversampled portions can sample 6 images per second (three times the base rate) or 10 images per second (5 times the base rate) and triple or quintuple the resultant number of samples in the undersampled period. Three times and five times are merely exemplary, and one of skill in the art can determine the appropriate oversampling or undersampling rates to achieve a sufficient magnitude of samples at a given period.

In another example, the training data for the skewed positions is further augmented by doing a Y-axis flip of the images within the training data set. The Y-axis flip effectively doubles the available data of each of the skew angles (0-4, 6-10) because an image of a skew angle of −10 degrees subjected to a Y-axis flip now shows an image of a skew angle of +10 degrees. Alternative augmentation techniques can be used in addition to, or instead of, the Y-axis flip. By way of non-limiting example, these augmentation techniques can include per-pixel operations including increasing/decreasing intensity and color enhancement of pixels, pixel-neighborhood operations including smoothing, blurring, stretching, skewing and warping, applying Gaussian blur, image based operations including mirroring, rotating, and shifting the image, correcting for intrinsic or extrinsic camera alignment issues, rotations to mimic uneven terrain, and image superposition. Augmented images are added to the base images in the training set to further increase the number of samples at each position.

With continued reference to FIGS. 1 and 2, FIG. 3 illustrates a method for generating the training set. Initially a set of camera images are generated in a “Generate Controlled Image Set” step 210. Once the controlled image set is generated, each image from the video feed is tagged with the known angular position of the ego part 20 at that frame in a “Tag Images” step 220. In some examples, each image from multiple simultaneous video feeds is tagged independently. In others, the images from multiple cameras are combined into a single composite image, and the composite image is tagged as a single image. Once tagged, the images are provided to the data bin corresponding to the assigned tag. FIGS. 4A and 4B illustrate an exemplary composite image 300 combining a driver side image B with a passenger side image A into a single image to be used by the training data set. Any alternative configuration of the composite images can be used to similar effect, including those having additional images beyond the exemplary composite image 300 combining two images. In such examples, the composite image is generated during the “Tag Images” step 220.

Once tagged, the images are augmented using the above described augmentation process to increase the size of the training set in an “Augment Training Data” step 230. The full set of tagged and augmented images is provided to a training database in a “Provide Images to Training Set” step 240. The process 200 is then reiterated with a new trailer (ego part 20) in order to further increase the size and accuracy of the training set, as well as to allow the trained neural network to be functional on multiple ego parts 20, including previously unknown ego parts 20.

In some examples, the neural network determination can be further aided by the inclusion of one or more markings on the ego part 20. By way of example, inclusion of corner markings and/or edge line markings on the corners and edges of the ego part 20 can aid the neural network in distinguishing the corners and edge lines in the image from adjacent sky, road, or other background features.

In yet another exemplary implementation, one system to which the determined ego part position can be provided is a trailer panning system. The trailer panning system adjusts camera angles of the cameras 30 in order to compensate for the position of the trailer, and allow the vehicle operator to receive a more complete view of the environment surrounding the vehicle during operation. Each camera 30 includes a predefined camera angle corresponding to each trailer position, and when a trailer position is received from the trailer position detection system, the mirror replacement cameras are panned to the corresponding position.

In yet another implementation, the approximate position can be provided to a collision avoidance system. The collision avoidance system detects potential interactions with vehicles, objects, and pedestrians that may result in an accident. The collision avoidance system provides a warning to the driver when a potential collision is detected. By integrating the position detection system into the collision avoidance system, the collision avoidance system can account for the approximate position of the trailer when detecting or estimating an incoming collision.

By utilizing the above training method, the deployed neural network is able to recognize boundaries of trailers, and other ego parts, that the neural network has not previously been exposed to. This ability, in turn, allows the neural network to determine the approximate position of any number of new or distinct ego parts without requiring lengthy training of the neural network for each new part.

In another implementation, the trailer position detection system is integrated with trailer marking and distance line systems, to further enhance vehicle operations. As used herein, “distance lines” refer to automatically generated lines within a video feed that identify a distance of an object from the vehicle and/or the attached ego part.

The trailer marking system is tied to key-points of the vehicle, and generates markings in an image plane identifying where the key-points are located. By way of example, the key-points can include a trailer-end, a rear wheel location, and the like. The position of these elements is extracted from within the image plane rather than interpreted form the road plane. Due to extraction from the image plane, the key-point markings are immune to changes in intrinsic elements of the camera over time, as well as being immune to variations in a camera mount, or terrain through which the vehicle is traveling.

In order to improve the accuracy of identifying the positions of the key-points, the trailer marking system communicates with the position detection system described above and guided by the most likely angular position of the trailer in determining the trailer marking positions.

Distance lines, as generated by the distance line system, are lines superimposed on an image presented to the driver or operator of the vehicle. The lines correspond to pre-defined distances from the ego part, and can be color coded or include numerical indicators of the distance between the ego part and the line. By way of example, the distance lines can be positioned at 2 meters, 5 meters, 10 meters, 20 meters, and 50 meters, from the ego part. The distance lines serve as a reference for the driver to understand distances around the ego part to judge when objects come too close to the ego part. The distance lines are tied to the road plane, and conversion from the road plane to the image can be difficult.

In order to address the difficulty, the trailer marking system uses the neural network system to identify key points and (in some examples) to perform a 3D fitting of the trailer or other ego part. Once the 3D fitting is performed the distance lines system overlays the distance lines in the image plane based on a static projection model derived from an average camera and camera placement. This system assumes a flat road/flat terrain, and becomes less accurate as the flatness of the terrain decreases (i.e. becomes more hilly). Alternative factors, such as a low pitch on the camera, can further affect or reduce the accuracy of the distance lines.

To reduce the inaccuracies described above, one example system loads a terrain map, and correlates an accurate position of the vehicle with the features of the terrain map. By way of example, the actual position of the vehicle can be determined using a global positioning system (GPS), cell tower location, or any other known location identification system. Once the actual location of the vehicle is correlated with the terrain on the map, the distance lines can be automatically adjusted to compensate for the terrain at the vehicles location and direction.

In another example, the distance lines can be generated using an algorithmic methodology that estimates the distances between lanes around the vehicle, measures the projected lanes in the rear view and uses a triangulation system to generate distance lines far behind the vehicle. This system assumes that a lane width is maintained relatively constant and utilizes lane markings painted on the road. Alternatively, the system can identify a width of the entire road, and use a similar triangulation process based on the width of the road, rather than the width of the lanes.

Each of the above examples can also be integrated into a single distance line system that automatically places the distance lines while accounting for terrain features and lane width.

While discussed herein with regards to a convolutional neural network, it is appreciated that the techniques and systems described herein can be applied using any type of neural network to achieve similar results. One of skill in the art will appreciate that each neural network has distinct advantages and disadvantages in any given application, and can determine an appropriate neural network to use for a given situation.

With further reference to the above described system, examples utilizing a camera on each side of the vehicle (such as the illustrated views of FIGS. 4A and 4B) are able to capture the full angular range of the ego part and the neural network is able to then find the position of the ego part corners within the viewing plane of the cameras. This approach proves to be robust in that it is functional regardless of the direction of travel of the vehicle. However, the angular position determined by the neural network is approximate, and can be off by several degrees. For certain operations, this error is acceptable. For other operations, such as the superimposing of edge markings and/or corner markings over the operator view or the superimposing of distance lines within the operator view, which requires higher angular accuracy, refinement of the determined angle may be desirable.

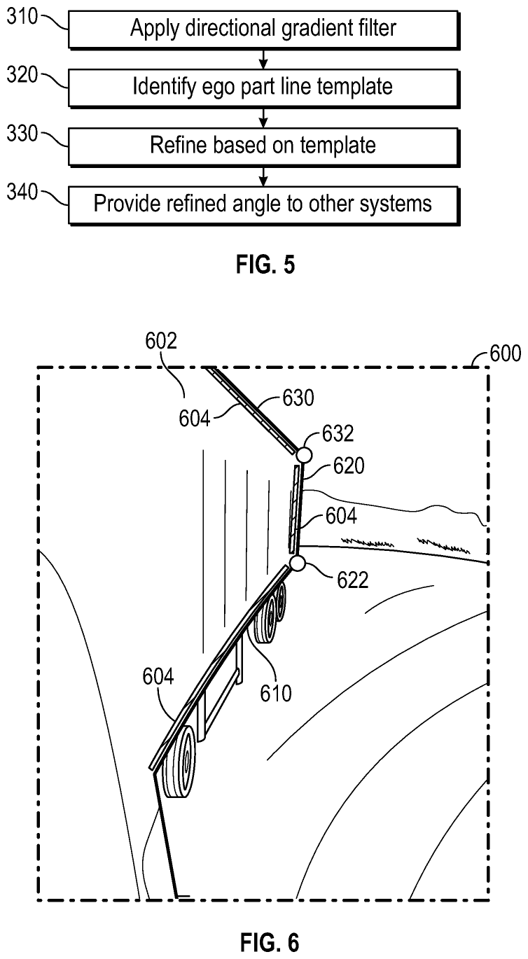

With continued reference to FIGS. 1-4, FIG. 5 illustrates an exemplary operation 300 in which the position detection system 40 refines the angular position using a trailer line matching algorithm.

Initially the camera streams are provided to a direction gradient filter in an “Apply Direction Gradient Filter” step 310. Within a transition between a straight ego part configuration (e.g. zero degree ego part angle, or center position) and a full turn (e.g. 90 degree ego part angle, or the farthest left or right position), each specific ego part angle corresponds approximately to a given ego part line 610 within an image plane 600. An example image plane 600 is illustrated in FIG. 6. While illustrated in the example as the bottom line 610 of the ego part 602, it is appreciated that alternative lines 620, 630, corners 622, 632, or combinations thereof can be used to the same effect. The ego part 602 illustrated in the example of FIG. 6 includes edge markings 604 disposed along multiple edges of the trailer 602. The edge markings assist the identification of the angular position, and can further enhance the functionality of the gradient filters by applying a strong directional gradient to the image, with the strong directional element corresponding to the direction of the edge that the edge marking 604 is adjacent to. In alternative examples, the edge markings 604 can be omitted, and the system is configured to determine an edge position and/or a corner position using any alternative technique. One distinctive feature of the image plane 600 of ego parts 602 is that they typically exhibit strong gradients, with the gradients corresponding to the ego part lines 610.

Simply filtering the image for strong gradients may not be specific enough in order to identify the ego part lines or corners, as natural environments often include an abundance of gradients in varying directions and in varying parts of the image. To improve this detection, the directional gradient filter additionally filters for the orientation of the gradients based on the expected orientations of the ego part line 610, 620, 630 being searched for. By way of example, if the bottom edge of the ego part 602 is being used, the directional gradient filter filters for linear gradients having a positive slope.

In some examples, the gradient filtering includes filters that have orientations that vary depending on which portion of the image is being filtered. By way of example, one gradient filter may favor lines oriented horizontally at a base of the image, where the base of the trailer is expected and favor relatively vertical lines at a top of the image where an end of the trailer is expected.

Once one or more gradients have been identified in the image via the directional gradient filter the angular position system 40 of the vehicle 10 uses the neural network derived approximate angular position to identify an ego part line template corresponding to the actual image in an “identify ego part line template” step 320. Stored within the position detection systems are multiple ego part line templates indicating an approximate location within the viewing pane 600 that an ego part line 610, 620, 630 is expected to appear for a given determined angle.

After the neural network has identified the approximate position, the corresponding template is loaded and the viewing pane 600 is analyzed beginning with the location where the expected ego part line 610, 620, 630 should be. Based on the deviation of the actual ego part line 610, 620, 630 within the viewing pane 600, the determined approximate angular position is refined to account for the deviation in a “Refine based on Template” step 330. The refined angle is then provided to other vehicle systems that may need a more precise angular position of the ego part in a “Provide Refined Angle to Other Systems” step 340

It is further understood that any of the above described concepts can be used alone or in combination with any or all of the other above described concepts. Although an embodiment of this invention has been disclosed, a worker of ordinary skill in this art would recognize that certain modifications would come within the scope of this invention. For that reason, the following claims should be studied to determine the true scope and content of this invention.

1. A vehicle comprising:
a vehicle body having a plurality of cameras and at least one ego part connection;
an ego part connected to the vehicle body via the ego part connection;
a position detection system communicatively coupled to the plurality of cameras and configured to receive a video feed from the plurality of cameras, the position detection system being configured to identify an ego part at least partially imaged in the video feed and configured to determine a closest angular position of the ego part relative to the vehicle using a neural network; and
wherein the neural network is configured to determine a probability of the actual angular position being closest to each angular position in a set of predefined angular positions, and determine that the closest angular position of the ego part relative to the vehicle is the predefined angular position having the highest probability.

2. The vehicle of claim 1, wherein each camera in the plurality of cameras is a mirror replacement camera, and wherein a controller is configured to receive the determined closest angular position and pan at least one of the cameras in response to the received angular position.

3. The vehicle of claim 1, wherein the ego part is a trailer, and wherein the trailer includes at least one of an edge marking and a corner marking.

4. The vehicle of claim 3, wherein the neural network is configured to determine an expected position of the at least one of the edge marking and the corner marking within the video feed from the plurality of cameras based on the determined closest angular position of the ego part.

5. The vehicle of claim 4, further comprising verifying an accuracy of the determined closest angular position of the ego part by analyzing the video feed from the plurality of cameras and determining that the at least one of the edge marking and the corner marking is in the expected position within the video feed.

6. The vehicle of claim 1, wherein the neural network is trained via transfer learning from a first general neural network to a second specific neural network.

7. The vehicle of claim 6, wherein the first general neural network is pre-trained to perform a task related to identifying the ego part at least partially imaged in the video feed and determining the closest angular position of the ego part relative to the vehicle using a neural network.

8. The vehicle of claim 7, wherein the related task comprises image classification.

9. The vehicle of claim 7, wherein the neural network is the second specific neural network, and is trained to identify the ego part at least partially imaged in the video feed and determine the closest angular position of the ego part relative to the vehicle using a neural network using the first general neural network.

10. The vehicle of claim 9, wherein the second specific neural network is trained using a smaller training set than the first general neural network.

11. The vehicle of claim 1, wherein the neural network includes a number of output neurons equal to the number of predefined positions.

12. The vehicle of claim 1, wherein determining the probability of the actual angular position being closest to each angular position in a set of predefined angular positions, and determining that the closest angular position of the ego part relative to the vehicle is the predefined angular position having the highest probability comprises verifying the determined closest angular position using at least one contextual clue.

13. The vehicle of claim 12, wherein the at least one contextual clue includes at least one of a traveling direction of the vehicle, a speed of the vehicle, a previously determined angular position of the ego part, and a position of at least one key-point in an image.

14. The vehicle of claim 1, further comprising a trailer marking system configured to identify a plurality of key-points of the ego part and superimpose markings in a viewing plane over each key-point in the plurality of key-points of the ego part.

15. The vehicle of claim 14, wherein the plurality of key-points includes at least one of a trailer-end and a rear wheel location.

16. The vehicle of claim 14, wherein each key-point in the plurality of key-points is extracted from an image plane and is based at least in part on the determined closest angular position of the ego part.

17. The vehicle of claim 14, wherein the trailer marking system includes at least one physical marking disposed on the trailer, wherein the physical marking corresponds with a key-point in the plurality of key-points.

18. The vehicle of claim 1, further comprising a distance line system configured to 3D fit the ego part within an image plane and overlay at least one distance line in the image plane based on a static projection model derived from an average camera and camera placement, wherein the distance line indicates a pre-defined distance between an identified portion of the ego part and the at least one distance line.

19. The vehicle of claim 18, wherein the distance line system assumes flat terrain in positioning the distance line.

20. The vehicle of claim 18, wherein the distance line system further correlates an accurate position of the vehicle with a terrain map and utilizes a current grade of the ego part in positioning the distance line.
